(19) United States
(12) Patent Application Publication
(10) Pub. No.: US 2006/0130475 A1
(43) Pub. Date: Jun. 22, 2006

(54) Power generator with floats

(76) Inventor: Shia-Giow Yu, Fongshan City (TW)

Correspondence Address: POSZ LAW GROUP, PLC, 12040 SOUTH LAKES DR., SUITE 101, RESTON, VA, 20191, US

(21) Appl. No.: 11/012,694

(22) Filed: Dec. 16, 2004

(51) Int. Cl. F03B 17/02; F03B 13/18

(52) U.S. Cl. 60/495; 60/504

(57) ABSTRACT

A power generator has a reservoir, a tube, a drive assembly, and multiple floats. The reservoir is filled with a liquid and has a top opening and a side opening. The tube protrudes into the reservoir through the side opening. The drive assembly has four pedestals, four shafts, four sprockets and a chain. The shafts are rotatably mounted respectively in the pedestals. The sprockets are mounted on and rotate the shafts. The chain is mounted around and engages the sprockets in a loop. Each float has a buoyant body and multiple annular seals. The floats are attached to the chain so at least one float is in the tube at all times and are forced up in the reservoir by buoyancy when the floats are submerged in the reservoir. The annular seals are mounted around the floats to prevent liquid from leaking out of the tube.

### BACKGROUND OF THE INVENTION

1. Field of the Invention

The present invention relates to a power generator, especially to a power generator driven by buoyant floats.

2. Description of the Prior Arts

Virtually all machines require a device to drive the machines. No matter what apparatuses are used to drive the devices, the apparatuses need energy resources like electricity, fuel, etc. However, depletion of expendable energy resources is reaching a crisis level and is becoming more and more serious. Therefore, people have to think about other ways generating power without wasting the Earth's precious energy resources.

To overcome the shortcomings, the present invention provides a power generator with floats to mitigate or obviate the aforementioned problems.

### SUMMARY OF THE INVENTION

The main objective of the present invention is to provide a power generator that uses buoyancy to generate power.

A power generator in accordance with the present invention has a reservoir, a tube, a drive assembly and multiple floats. The reservoir is filled with a liquid and has a top opening and a side opening. The tube protrudes into the reservoir through the side opening. The drive assembly has four pedestals, four shafts, four sprockets and a chain. The shafts are rotatably mounted respectively in the pedestals, and at least one of the shafts is also a drive shaft. The sprockets are mounted respectively on the shafts and rotate the shafts. The chain is mounted around and engages the sprockets in a loop. Each float has a buoyant body and multiple annular seals. The floats are attached to the chain so at least one float is in the tube at all times and are forced up in the reservoir by buoyancy when the floats are submerged in the reservoir. The annular seals are mounted around the floats to prevent liquid from leaking out of the tube.

Other objectives, advantages and novel features of the invention will become more apparent from the following detailed description when taken in conjunction with the accompanying drawings.

### BRIEF DESCRIPTION OF THE DRAWINGS

FIG. 1 is a front view in partial section of a power generator with floats in accordance with the present invention;

FIG. 2 is a side view of a float, an annular seal and a chain of the power generator in FIG. 1;

FIG. 3 is a top view in partial section of the float, the annular seal and the chain in FIG. 2;

FIG. 4 is a front view in partial section of the float, the annular seal and the chain in FIG. 2 with the annular seal engaging the chain;

FIG. 5 is a front view in partial section of the float, the annular seal and the chain in FIG. 2 with the annular seal disengaging from the chain; and

FIG. 6 is a top view in partial section of another embodiment of a float, the annular seal and the chain in accordance with the present invention.

### DETAILED DESCRIPTION OF THE PREFERRED EMBODIMENTS

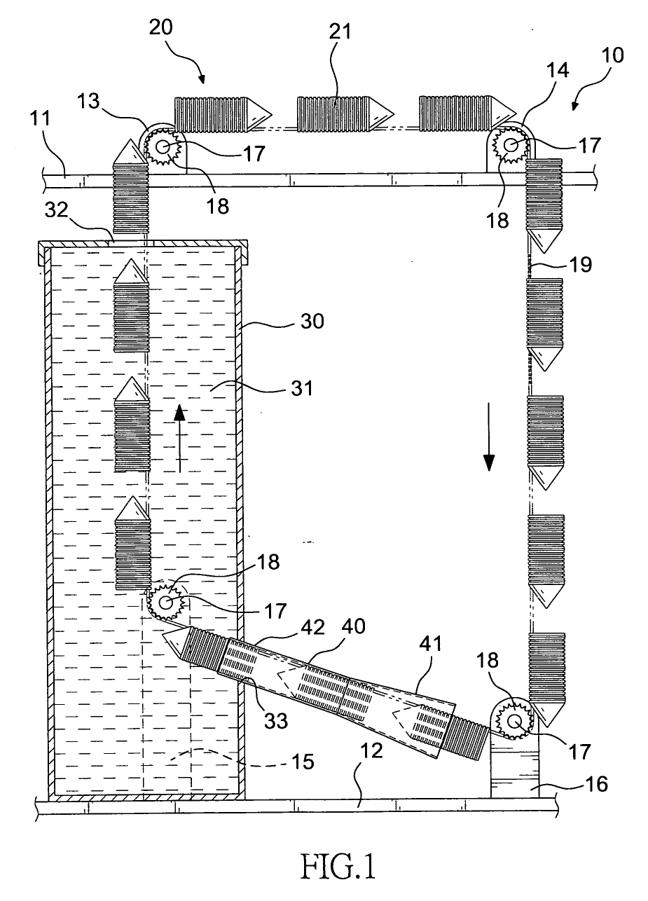

With reference to FIG. 1, a power generator with floats in accordance with the present invention comprises a lower bracket (12), an upper bracket (11), a reservoir (30), a tube (40), a drive assembly (10) and multiple floats (20).

The lower bracket (12) has a left end and a right end. The upper bracket (11) is mounted above the lower bracket (12) and has a left end and a right end.

The reservoir (30) is mounted on the left end of the lower bracket (12), is filled with a liquid (31) and has a top, a bottom, a sidewall, a top opening (32), an optional bottom opening and a side opening (33). The top opening (32) is formed in the top, and the bottom opening is formed in the bottom. The side opening (33) is formed through the sidewall a distance from the lower bracket (12).

The tube (40) is hollow, is mounted through the side opening (33) in the reservoir (30), may be obliquely mounted through the side opening (33) and has an inner segment (42) and an outer segment (41). The inner segment (42) is cylindrical, is mounted in the side opening (33) and has an inside end, an outside end, an outside surface and an inside surface. The outside surface forms a watertight seal with the side opening (33). The inside surface has an inside diameter. The outside segment (41) is a truncated cone, is connected to the inner segment (42), is a guide and has an inside end and an outside end. The inside end is connected to the outside end of the inner segment (42) and has an inside diameter. The inside diameter is the same as the inside diameter of the inner segment (42). The outside end has an inside diameter larger than the inside diameter of the inside end.

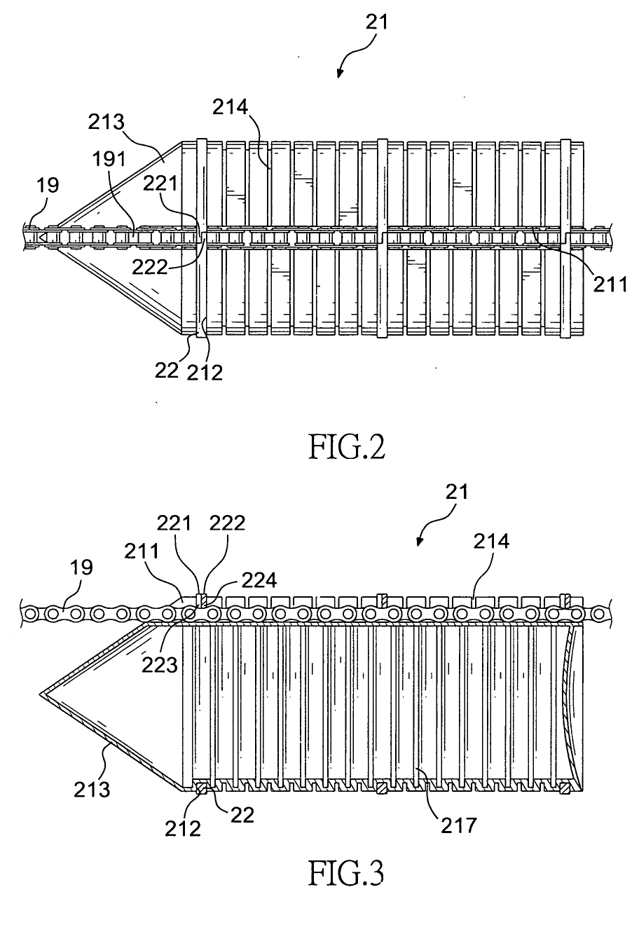

The drive assembly (10) has an upper reservoir pedestal (13), an upper return pedestal (14), a lower reservoir pedestal (15), a lower return pedestal (16), four shafts (17), four sprockets (18) and a chain (19). The upper reservoir pedestal (13) is mounted on the upper bracket (11) near the left end above the top opening (32) in the reservoir (30) and has a transverse hole. The upper return pedestal (14) is mounted on the upper bracket (11) near the right end, is aligned with the upper reservoir pedestal (13) and has a transverse hole. The lower reservoir pedestal (15) is mounted on the bottom of the reservoir (30), may be mounted on the lower bracket (12) near the left end, may protrude through and seal the bottom opening in the reservoir (30), may extend into the reservoir (30), is aligned with the upper reservoir pedestal (13) and has a transverse hole and a height. The lower return pedestal (16) is mounted on the lower bracket (12) near the right end, is aligned with the upper return pedestal (14) and the lower reservoir pedestal (15) and the tube (40) and has a transverse hole and a height. The height of the lower return pedestal (16) may be shorter than the height of the lower reservoir pedestal (16). The shafts (17) are rotatably mounted respectively in the transverse holes in the pedestals (13, 14, 15, 16). The sprockets (18) are mounted respectively on the shafts (17). When the height of the lower reservoir pedestal (15) is higher than the height of the lower return pedestal (16), a line tangential to the sprocket (18) on the lower return pedestal (16), passing through the tube (40) and tangential to the sprocket (18) on the lower reservoir pedestal (15) will intersect the lower bracket (12) at an acute angle. With further reference to FIG. 2, the chain (19) is mounted in a loop around the sprockets (18), passes through the tube (40) and the top opening (32) in the reservoir (30) and has multiple link openings (191).

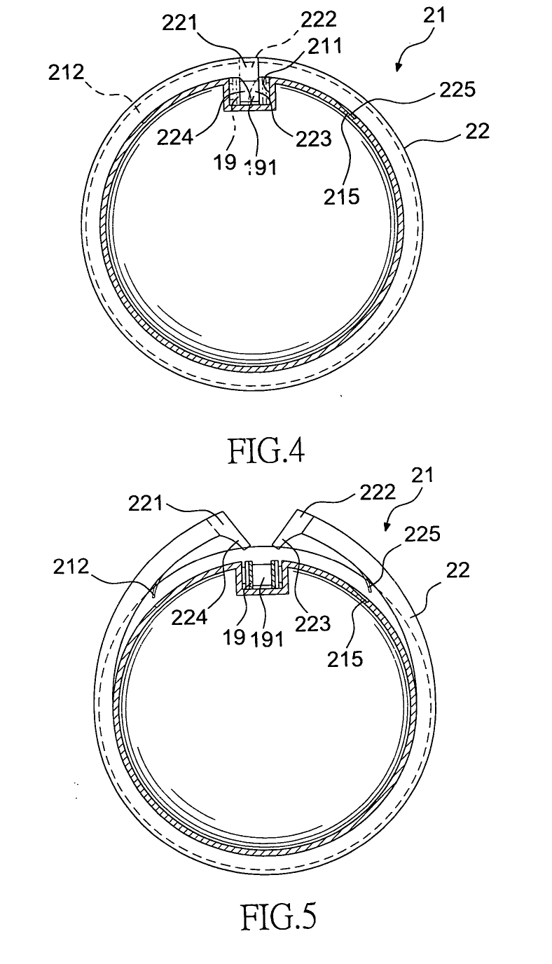

With further reference to FIGS. 3, 4, 5 and 6, the floats (20) are attached to the chain (19) such that at least one float (20) is in the inner segment (42) of the tube (40) at all times and may be equally spaced along the chain (19). Each float (20) has a buoyant body (21) and multiple annular seals (22).

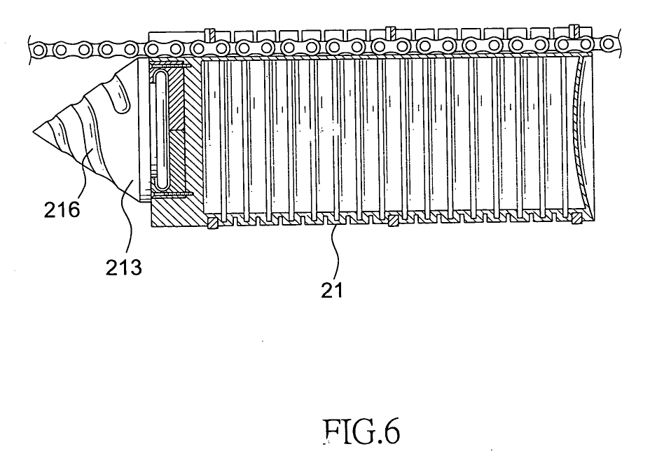

Each buoyant body (21) has a front end, a rear end, an outer diameter, an outer surface, an inner surface, an optional conical head (213) and an optional concave rear. The outer diameter of the buoyant bodies (21) corresponds to the inside diameter of the inner segment (42) of the tube (40). The outer surface has a longitudinal slot (211), multiple annular seal slots (212) and multiple optional corrugation grooves (214). The longitudinal slot (211) is formed in the outer surface and attaches the chain (19) securely to the buoyant body (21). The annular seal slots (212) are formed in the outer surface and have multiple ratchet recesses (215). Two ratchet recesses (215) are formed in each annular seal slot (212) respectively on opposite sides of the longitudinal slot (211). The outer corrugation grooves (214) are formed in the outer surface between the annular seal slots (212). The inner surface has multiple optional inner corrugation grooves (217) between the front end and the rear end. The conical head (213) is formed on the front end, may be rotatable and has an optional spiral recess (216) as shown in FIG. 6. The concave rear is formed in the rear end.

The annular seals (22) are mounted respectively in the annular seal slots (212) to prevent liquid (31) from leaking out of the tube (40). Each annular seal (22) has an inner surface, two resilient pawls (225) and two overlapping ends (221). The resilient pawls (225) are formed on the inner surface respectively near the overlapping ends (221) and correspond respectively to and selectively engage the ratchet recesses (215). The overlapping ends (221) respectively have optional protruding keys (223) that extend inward and selectively engage one of the link openings (191) of the chain (19) aligned with the annular seal (22) when the float (20) passes through the inner segment (42) of the tube (40).

When the floats (21) enters the tube (40), the resilient pawls (225) respectively engage the ratchet recesses (215) and force the overlapping ends (221) together as the inner surface of the tube (40) squeezes the annular seal (22) into the annular seal slot (212). When the float (20) leaves the tube (40), the overlapping ends (221) spread and expose the link opening (191) in the chain (19) so the sprockets (18) can engage the chain (19). When the float (20) leaves the tube (40), the optional protruding keys (223) also disengage from and expose the link opening (191) and the resilient pawls (225) disengage from the ratchet recesses (215).

During operation of the power generator, buoyancy of the floats (20) causes the floats (20) in the liquid (31) in the reservoir (30) to rise and pull the chain (19) around the sprockets (18). The conical head (213) can reduce the resistance to the movement of the floats (21) in the liquid (31). Pulling the chain (19) around the sprockets (18) causes the sprockets (18) to rotate and to rotate the shafts (17). The rotating shafts (17) can drive other devices such as trickle chargers for batteries, reciprocating pumps and the like without depletion of an energy source.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A power generator with floats comprising
a lower bracket having a left end and a right end;
an upper bracket mounted above the lower bracket and having a left end and a right end;
a reservoir mounted on the left end of the lower bracket, filled with a liquid and having
a top;
a bottom;
a sidewall;
a top opening formed in the top; and
a side opening formed through the sidewall a distance from the lower bracket;
a tube being hollow, mounted through the side opening in the reservoir and having
an inner segment being cylindrical, mounted in the side opening and having
an inside end;
an outside end;
an outside surface forming a watertight seal with the side opening; and
an inside surface having an inside diameter; and
an outer segment being a truncated cone, connected to the inner segment, being a guide and having
an inside end connected to the outside end of the inner segment and having an inside diameter the same as the inside diameter of the inner segment; and
an outside end having an inside diameter larger than the inside diameter of the inside end;
a drive assembly having
an upper reservoir pedestal mounted on the upper bracket near the left end above the top opening in the reservoir and having a transverse hole;
an upper return pedestal mounted on the upper bracket near the right end, aligned with the upper reservoir pedestal and having a transverse hole;
a lower reservoir pedestal mounted on the bottom of the reservoir, aligned with the upper reservoir pedestal and having a transverse hole and a height;
a lower return pedestal attached mounted on the lower bracket near the right end, aligned with the upper return pedestal and the lower reservoir pedestal and the tube and having a transverse hole and a height;
four shafts rotatably mounted respectively in the transverse holes in the pedestals;
four sprockets mounted respectively on the shafts; and
a chain mounted in a loop around the sprockets, passing through the tube and the top opening in the reservoir and having multiple link openings;
multiple floats attached to the chain such that at least one float is in the inner segment of the tube at all times, and each float having
a buoyant body having
a front end;
a rear end;
an outer diameter corresponding to the inside diameter of the inner segment of the tube;
an outer surface having;
a longitudinal slot formed in the outer surface and attaching the chain securely to the buoyant body; and
multiple annular seal slots formed in the outer surface and having two ratchet recesses formed in each annular seal slot respectively on opposite sides of the longitudinal slot; and
an inner surface; and
multiple annular seals mounted respectively in the annular seal slots to prevent liquid from leaking out of the tube, and each annular seal having
an inner surface;
two resilient pawls formed on the inner surface and corresponding respectively to and selectively engaging the ratchet recesses; and
two overlapping ends.

2. The power generator as claimed in claim 1, wherein
the height of the lower reservoir pedestal is higher than the height of the lower return pedestal; and
the tube is mounted obliquely through the side hole.

3. The power generator as claimed in claim 1, wherein
the overlapping ends of each annular seal respectively have protruding keys that extend inward and selectively engage one of the link openings of the chain aligned with the annular seal when the float passes through the inner segment of the tube.

4. The power generator as claimed in claim 2, wherein
the overlapping ends of each annular seal respectively have protruding keys that extend inward and selectively engage one the link openings of the chain aligned with the annular seal when the float passes through the inner segment of the tube.

5. The power generator as claimed in claim 1, wherein the floats are equally spaced along the chain.

6. The power generator as claimed in claim 4, wherein the floats are equally spaced along the chain.

7. The power generator as claimed in claim 1, wherein each buoyant body further has a conical head formed on the front end.

8. The power generator as claimed in claim 6, wherein each buoyant body further has a conical head formed on the front end.

9. The power generator as claimed in claim 7, wherein each buoyant body further has a spiral recess formed in the conical head and the conical head is rotatable.

10. The power generator as claimed in claim 8, wherein each buoyant body further has a spiral recess formed in the conical head and the conical head is rotatable.

11. The power generator as claimed in claim 1, wherein each buoyant body further has a concave rear formed in the rear end.

12. The power generator as claimed in claim 10, wherein each buoyant body further has a concave rear formed in the rear end.

13. The power generator as claimed in claim 1, wherein each float buoyant body further has multiple outer corrugation grooves formed in the outer surface between the annular seal slots.

14. The power generator as claimed in claim 12, wherein each buoyant body further has multiple outer corrugation grooves formed in the outer surface between the annular seal slots.

15. The power generator as claimed in claim 1, wherein each buoyant body further has multiple inner corrugation grooves formed in the inner surface between the front end and the rear end.

16. The power generator as claimed in claim 14, wherein each buoyant body further has multiple inner corrugation grooves formed in the inner surface between the front end and the rear end.

17. The power generator as claimed in claim 1, wherein
the reservoir further comprises a bottom opening formed in the bottom; and
the lower reservoir pedestal mounted on the lower bracket near the left end, protrudes through and seals the bottom opening in the reservoir and extends into the reservoir.

18. The power generator as claimed in claim 16, wherein
the reservoir further comprises a bottom opening formed in the bottom; and
the lower reservoir pedestal mounted on the lower bracket near the left end, protrudes through and seals the bottom opening in the reservoir and extends into the reservoir.
